(19) United States
(12) Patent Application Publication
(10) Pub. No.: US 2006/0133558 A1
(43) Pub. Date: Jun. 22, 2006

(54) Mechanism to aid a phase interpolator in recovering a clock signal

(76) Inventors: Ronald W. Swartz, Granite Bay, CA (US); Adhiveeraraghavan Srikanth, Folsom, CA (US); Wen-Lung Tu, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/017,269

(22) Filed: Dec. 20, 2004

(51) Int. Cl. H04L 7/00

(52) U.S. Cl. 375/371

(57) ABSTRACT

According to one embodiment, a phase interpolator comprising an alternating current (AC) coupling capacitor, and a common mode bias keeper circuit coupled to the AC coupling capacitor is presented. In one embodiment, the AC coupling capacitor may be located between a mixer circuit and an amplifier within the phase interpolator, along with the common mode bias keeper circuit coupled to the AC coupling capacitor. Alternately, in another embodiment, a second AC coupling capacitor may be located between a pre-conditioner circuit and the mixer circuit of the phase interpolator, with a second common mode bias keeper circuit coupled to the second AC coupling capacitor. In another embodiment, the AC coupling capacitor could be located only between the pre-conditioner circuit and the mixer circuit, along with the common mode bias keeper coupled to the AC coupling capacitor.

### FIELD OF THE INVENTION

The present embodiments of the invention relate generally to phase interpolators and, more specifically, relate to such interpolators useful in recovering a clock from serial data sent to a receiver.

### BACKGROUND

In many data communication arrangements, separate clock signals are not transmitted with the data. This requires recovering the clock from the data at the receiving end in order to then recover the data. When transmitting the clocked data across a transmission medium, noise in the data signal, such as jitter and phase skew, reduces the sampling window for the data. Duty cycle distortion, for instance, is caused by non-symmetric positive and negative duty cycles of a data symbol and can show up either as a high frequency correlated jitter or as a phase step. The jitter, phase skew, and duty cycle distortion reduce the perceived sampling window by the receiver.

Phase interpolator circuits are increasingly used in embedded clock data recovery systems to position the sampling clock at the center of the data eye. Phase interpolators typically use fixed phase clocks, generated from a Phase Locked Loop (PLL), and mix them appropriately to generate interpolated clocks that can be adjusted to be at the center of the data bit. Some implementations of phase interpolator circuitry contain pre-conditioner circuitry, mixer circuitry, and an amplifier. With the phase interpolator operating at multiple Gb/S speeds, any duty cycle corruption can result in improperly sampled data.

The fixed phase clocks at the input of the phase interpolator may have some cycle-cycle jitter from the source and power supply noise. There is also a possibility of phase skew between the adjacent clocks that are mixed in the phase interpolator. This jitter and phase skew lead to duty cycle distortion in phase interpolator outputs.

A conventional phase interpolator circuit is very sensitive to input jitter and layout mismatches which may result in poor quality clocks. With jitter and phase skew in the input clocks, the outputs of the pre-conditioner circuitry in a phase interpolator may have different common mode voltages. These different common mode voltages cause differing operating points in the differential mixer circuitry of the phase interpolator. This may result in duty cycle distortion in the phase interpolator output clocks and, consequently, improperly sampled data. With higher speeds and jitter associated with clocks increasing, a phase interpolator that can provide cleaner clocks, even with significant phase skew and power supply noise induced jitter on the input clocks, will help reduce the occurrence of improperly sampled data.

### DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a block diagram of a simple communication system;

FIG. 2 illustrates a block diagram of a receiver of the type in which a phase interpolator may be used;

FIG. 3 illustrates a block diagram of one embodiment of a phase interpolator;

FIG. 4 illustrates a graphical representation of ideal phase spacing of outputs of the phase interpolator;

FIG. 5 illustrates a graphical representation of non-ideal phase spacing of outputs of the phase interpolator;

FIG. 6 illustrates a circuit/block diagram of one embodiment of a phase interpolator; and

FIG. 7 is a flow diagram of one embodiment of a method for recovering an embedded clock from a data stream.

### DETAILED DESCRIPTION

A method and apparatus to reduce duty cycle distortion in a phase interpolator circuit is described. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring the present invention.

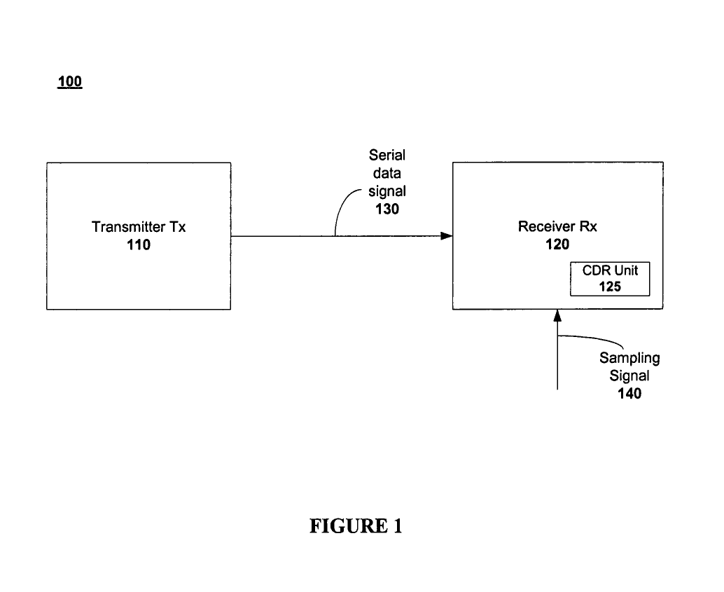

FIG. 1 is a block diagram of one embodiment of a simple communication system 100 that may be used to reduce duty cycle distortion in a phase interpolator circuit. The system 100 includes a transmitter (Tx) 110, a serial data signal 130, and a receiver (Rx) 120. Receiver unit 120 further includes a clock and data recovery (CDR) unit 125.

Transmitter 102 transmits the serial data signal 130 including, for example, a series of data symbols, to receiver 120. CDR unit 125 of receiver 120 samples serial data signal 130 (for example, symbols included in the serial data signal) to recover data from the serial data signal. CDR unit 125 samples serial data signal 130 at sample times established by a sampling signal 140 generated locally at receiver 120. In some embodiments, sampling signal 140 may be generated by a Phase Locked Loop (PLL).

In recovering data from the serial data signal 130, sampling signal 140 causes CDR unit 125 to sample the serial data signal at sample times coinciding with occurrences of a maximum Signal-to-Noise (S/N) level of the serial data signal. Often, however, there is a phase offset between the serial data signal and the sample signal, causing CDR unit 125 to sample serial data signal 130 at sub-optimal sample times, which can cause errors in recovering the data from serial data signal 130.

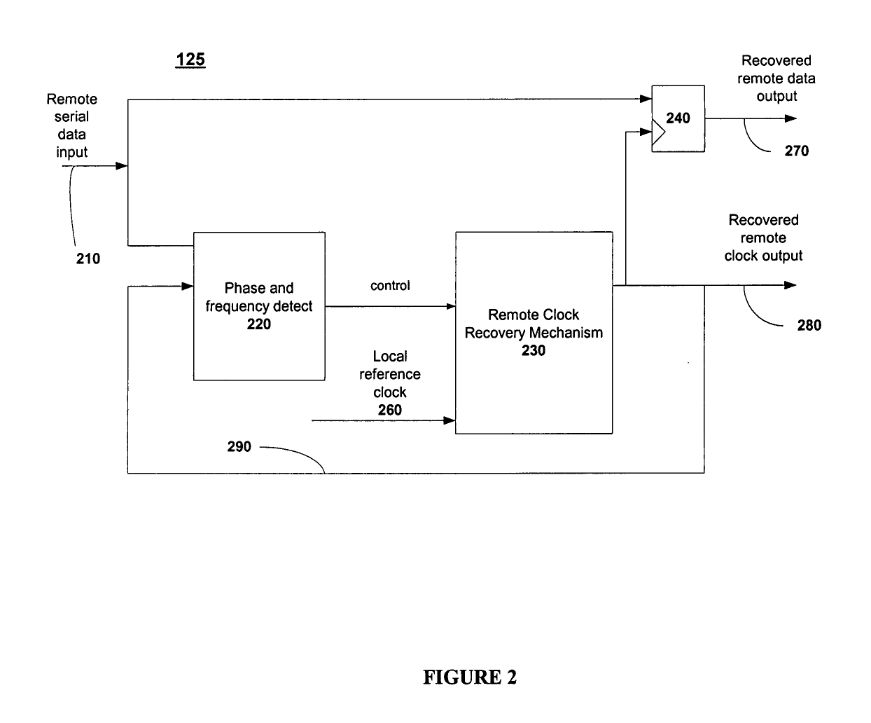

FIG. 2 is a block diagram of one embodiment of a CDR unit 125 of receiver 120 in which embodiments of a phase interpolator may be used. Remote serial data on line 210 is input to a phase detect circuit 220, which has as a second input the recovered remote clock signal on line 290. A control signal from block 220, which represents the difference in phase, is an input to a remote clock recovery mechanism 230, having as a second input a local reference clock on line 260. Local clock reference on line 260 may be the sampling signal 140 of FIG. 1.

The control signal from block 220 is used to vary the phase of the recovered remote clock until it is in a desired frequency and phase relationship with the incoming data. The recovered clock on line 290 is provided as an output and is used as a clock input to flip-flop 240 that is used to recover the data.

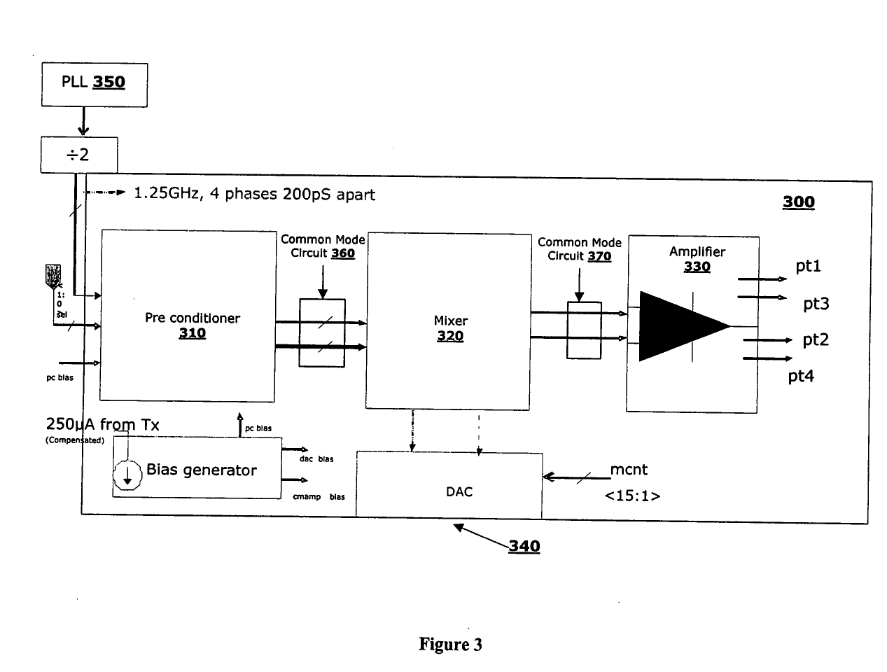

FIG. 3 is a block diagram of one embodiment of a phase interpolator. The phase interpolator 300 can be used as the remote clock recovery mechanism 230 in a system such as that of FIG. 2. However, the phase interpolator implementation in FIG. 3 is useful in any arrangement where interpolation between different clock phases is desired.

In the illustrated embodiment, the phase interpolator 300 includes three circuitry units: a pre-conditioner 310, a mixer 320, and an amplifier 330. Fixed phase clocks from a Phase Locked Loop (PLL) 350 are used as input clocks to the pre-conditioner 310. These fixed phase clocks are converted to triangle waves by the pre-conditioner 310. The pre-conditioner 310 is a square-to-triangle waveform shaper, which generates good overlap between the two phases. The output of the pre-conditioner 310 is a resistor-capacitor (RC) type of waveform rather than a triangle. This basically provides a good region of overlap between any two adjacent pre-conditioner output phases. The two output phases of the pre-conditioner are coupled to a common mode circuit 360.

Common mode circuit 360 contains circuitry to keep the pre-conditioner outputs biased at the same voltage. It forces the common mode of the pre-conditioner outputs to be the same, and consequently helps the pre-conditioner output signals swing around a fixed common mode to produce good differential signal crossovers and ideal clock outputs. Implementing the common mode circuit 360 may help produce proper phase spacing of the phase interpolator outputs after amplification. The output of the common mode circuit 360 is coupled to a mixer circuit 320.

At mixer circuit 320, the signal phases outputted from the pre-conditioner 310 are mixed proportionately based on proportionate current weighing. The mixer 320 takes in any of the plurality of adjacent triangular waves and mixes them to produce a resultant output that is close to sinusoidal in shape. The output of the mixer is controlled to produce an output whose phase is somewhere between the mixer input phases.

The proportionate current weighting implemented in the mixer cirucit is controlled by a Digital-to-Analog Converter (DAC) 340. The DAC 240 controls are generated based on edge and data samples, as well as the current position of the sampling clock. Proportional weighting of currents between IQ1 and IQ2, illustrated in FIG. 3, determines the output phase. The sum of the currents IQ1 and IQ2 is constant, K.

The output of the mixer 320 is analog and is fed to another common mode circuit 370. Common mode circuit 370 operates analogously to common mode circuit 360 to facilitate proper phase spacing of the outputs of mixer 320. Embodiments of the present invention may not require both common mode circuits 360 and 370. Some embodiments may implement only one of these common mode circuits, while other embodiments may implement both common mode circuits.

The output of the common mode circuit 370 is fed to an amplifier 330 that produces rail to rail (0V to VDD voltage swing) sampling clocks. Amplifier 330 may in some embodiments be a CMOS (Complementary Metal Oxide Semiconductor) level converter.

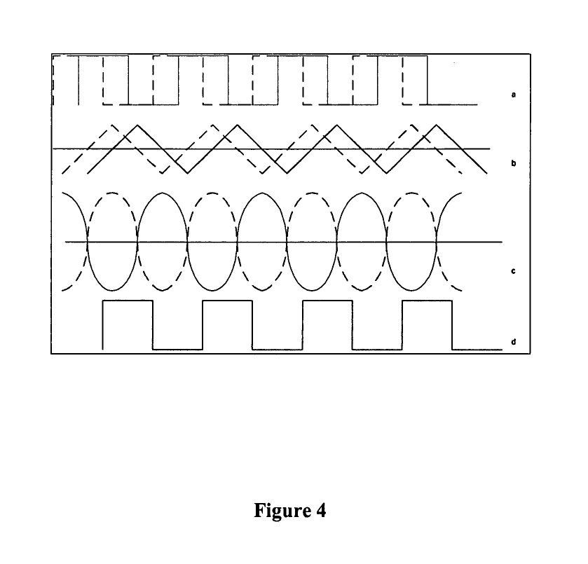

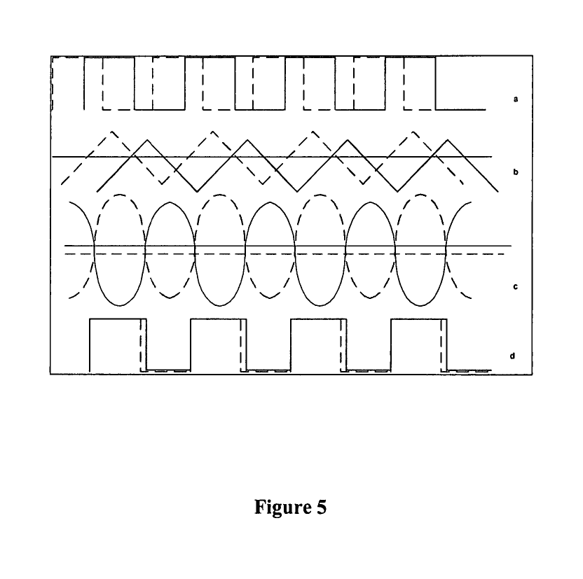

FIGS. 4 and 5 are graphical illustrations of phase spacing within the phase interpolator at each of the pre-conditioner 310 input, pre-conditioner 310 output, mixer 320 output, and phase interpolator output (i.e., amplifier 330 output). The pre-conditioner 310 input clocks that come out of the PLL 350 are routed several thousand microns and buffered periodically before they go to each phase interpolator in a multi-lane configuration. Generally, these fixed phase clocks at the input of pre-conditioner will have some cycle-cycle jitter from the source and power supply noise. There is also a possibility of phase skew between the adjacent clocks that are mixed.

FIG. 4 illustrates ideal phase spacing within the phase interpolator when there is no jitter or phase skew present in the input clocks to the phase interpolator. Phase spacing at each of the pre-conditioner input, pre-conditioner output, mixer output, and the phase interpolator output (amplifier output) is shown. Ideally, the phase spacing between two adjacent output phases is T/n pS, where T is the period in Pico seconds and n is the number of input phases within each period. For example, the phase spacing between Phase 1 and Phase 2, and Phase 2 and Phase 3, and Phase 3 and Phase 4, and Phase 4 and Phase 1, in an ideal 4-phase system will be T/4 pS.

In FIG. 4, line (a) depicts ideal pre-conditioner input phase spacing. Line (b) depicts the resulting phase spacing at the pre-conditioner output. Line (c) depicts the resulting mixer output phase spacing. Line (d) depicts the overall phase spacing at the phase interpolator output (at the amplifier).

FIG. 5 graphically depicts non-ideal phase spacing within the phase interpolator. Such a non-ideal scenario may occur when there is jitter and/or phase skew present in the input clocks to the phase interpolator. In general, the common mode and signal swing of the pre-conditioner outputs determine the bias point of the mixer outputs. The bias point of the mixer outputs is the pseudo common mode of the differential swings at the output of the mixer. As the pre-conditioner clocks are displaced in time due to jitter and skew, the outputs of the pre-conditioner can have different common modes. The different common modes at the pre-conditioner outputs may bias the mixer outputs to different voltage levels.

Furthermore, different common modes may cause mixer crossovers to be significantly different from expected values and result in long pulse-short pulse scenarios, thereby leading to duty cycle distortion in the phase interpolator outputs. With phase skews in the pre-conditioner input clocks, the pre-conditioner outputs swing around different common modes causing shifting of mixer output bias voltages. With phase skews (time) present, mixer output bias skews (voltage) result, leaving bad duty cycle clocks. In other words, poor phase spacing of the output clocks results. FIG. 5 illustrates the effect of non-ideal phase spacing of the pre-conditioner input clocks on the phase interpolator output.

In FIG. 5, line (a) depicts non-ideal pre-conditioner input phase spacing. Line (b) depicts the resulting phase spacing at the pre-conditioner output. Line (c) depicts the resulting mixer output phase spacing with skewed bias points. Line (d) depicts the overall phase spacing at the phase interpolator output (at the amplifier) with duty cycle distortion.

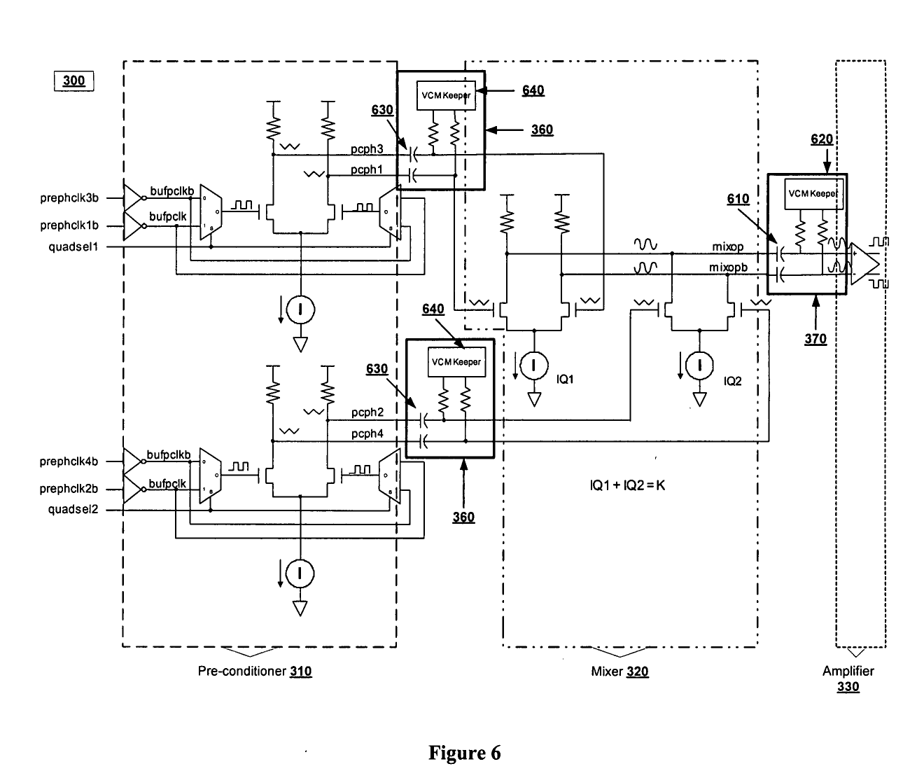

FIG. 6 illustrates a circuit/block diagram of one embodiment of a phase interpolator, such as phase interpolator 300 of FIG. 3, used to alleviate the duty cycle distortion in the phase interpolator circuit. The diagram includes circuit level implementation of the pre-conditioner 310, the mixer 320, the amplifier 330, and the common mode circuits 360, 370, as depicted in FIG. 3.

The common mode circuits 360, 370 include an alternating current (AC) coupling capacitor 610, 630, together with a common mode bias keeper circuit 620, 640. AC coupling capacitor 610, 630 and common mode bias keeper circuit 620, 640 operate together to maintain the common mode of the input signals to the common mode circuit 360, 370.

A common mode circuit 360 may be located between the pre-conditioner circuitry 310 and the mixer circuitry 320. Alternatively, in other embodiments, common mode circuit 370 may be located between the mixer circuitry 320 and the amplifier 330. One embodiment of the phase interpolator may include both common mode circuit 370 between the mixer circuitry 320 and the amplifier 330, and common mode circuit 360 between the pre-conditioner circuitry 310 and the mixer circuitry 320.

The embodiment of phase interpolator 300 presented in FIG. 6 may lessen differences in common mode bias voltages at the differential outputs of the mixer 320, keeping both outputs biased at the same voltage and thereby producing proper phase spacing after amplification. The embodiment of phase interpolator 300 also forces the common mode of the differential outputs of the pre-conditioner 310 to be one value and the common mode at the mixer 320 outputs to be the same. Consequently, the signals swing around a fixed common mode, thereby producing good differential signal crossovers and ideal clock outputs of the phase interpolator 300.

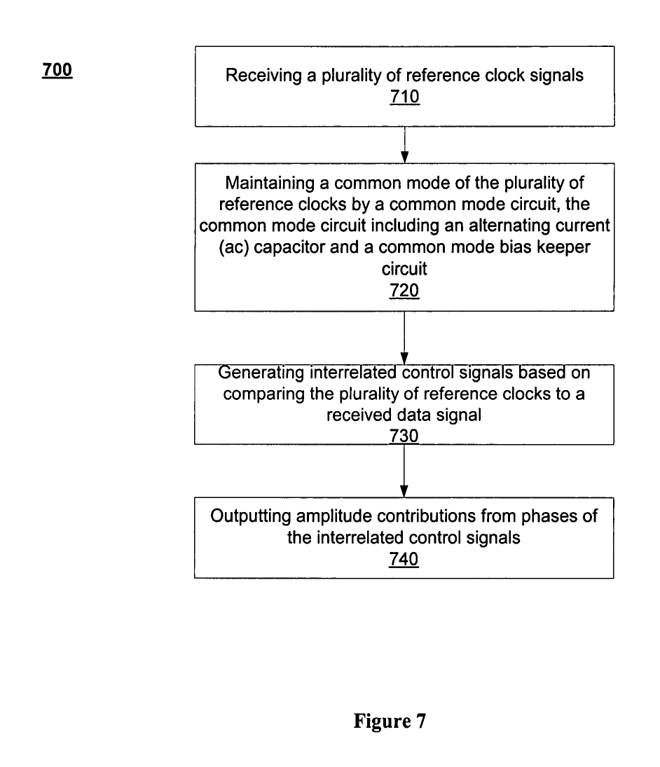

FIG. 7 is a flow diagram illustrating one embodiment of a method 700 for recovering an embedded clock from a data stream. Recovering the embedded clock from the data stream includes the phase interpolator maintaining the common mode of the signals it is processing. The flow diagram includes, at process block 710, receiving a plurality of reference clock signals. Process block 720 includes maintaining a common mode of the plurality of reference clock signals by a common mode circuit, the common mode circuit including an AC capacitor and a common mode bias keeper circuit. Next, process block 730 includes generating interrelated control signals based on comparing the plurality of reference clocks to a received data signal. Lastly, process block 740 includes outputting amplitude contributions from phases of the interrelated control signals.

Method 700 may be implemented in the embodiments of phase interpolator illustrated in FIGS. 3 and 6. More specifically, maintaining a common mode of the plurality of reference clock signals at process block 720, may be implemented with common mode circuits 360 and 370 as depicted in FIGS. 3 and 6. Furthermore, the maintaining of a common mode of the plurality of reference clock signals further includes forcing the common mode of the plurality of reference clock signals to be the same.

Embodiments of the phase interpolator and its accompanying data recovery scheme may be used in serial interfaces such as PCI Express. However, the embodiments of the phase interpolator implementation presented here are useful in any arrangement where serial data transfer over a networks system is desired.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A phase interpolator, comprising:
an alternating current (AC) coupling capacitor; and
a common mode bias keeper circuit coupled to the AC coupling capacitor,
wherein the AC coupling capacitor and the common bias keeper circuit operate together to force common modes of phase interpolator input signals to be the same.

2. The phase interpolator of claim 1, further comprising:
a pre-conditioner circuit;
a mixer circuit; and
an amplifier.

3. The phase interpolator of claim 2, further comprising the AC coupling capacitor and the common mode bias keeper circuit coupled between the mixer circuit and the amplifier.

4. The phase interpolator of claim 3, further comprising:
a second AC coupling capacitor coupled between the pre-conditioner circuit and the mixer circuit; and
a second common mode bias keeper circuit coupled to the second AC coupling capacitor.

5. The phase interpolator of claim 2, further comprising the AC coupling capacitor and the common mode bias keeper circuit coupled between the pre-conditioner circuit and the mixer circuit.

6. The phase interpolator of claim 2, wherein the pre-conditioner circuit further comprises circuitry to generate overlap between a plurality of phase interpolator input signals.

7. The phase interpolator of claim 2, wherein the mixer circuit further comprises circuitry to mix signals from a pre-conditioner circuit, the mixing based on proportionate current weighting controlled by a digital-to-analog converter.

8. The phase interpolator of claim 7, wherein the digital-to-analog converter generates controls for the proportionate current weighting based on edge and data samples, and on the current position of a sampling clock.

9. The phase interpolator of claim 2, wherein the amplifier further comprises circuitry to receive signals from the mixer circuit in order to produce rail-to-rail sampling clocks.

10. The phase interpolator of claim 9, wherein the amplifier is a Complementary Metal Oxide Semiconductor (CMOS) level converter.

11. A method, comprising:
receiving a plurality of reference clock signals;
maintaining a common mode of the plurality of reference clock signals by a common mode circuit, the common mode circuit including an alternating current (AC) capacitor and a common mode bias keeper circuit;
generating interrelated control signals based on comparing the plurality of reference clocks to a received data signal; and
outputting amplitude contributions from phases of the interrelated control signals.

12. The method of claim 11, wherein the maintaining a common mode further comprises forcing the common mode of the plurality of reference clock signals to be the same.

13. The method of claim 11, wherein the maintaining a common mode further comprises:
receiving the plurality of reference clock signals from a mixer circuit;
forcing the common mode of the plurality of reference clock signals to be the same; and
sending the reference clock signals to an amplifier.

14. The method of claim 13, further comprising:
receiving the plurality of reference clock signals from a pre-conditioner circuit;
forcing the common mode of the plurality of reference clock signals to be the same; and
sending the reference clock signals to the mixer circuit.

15. The method of claim 11, wherein the maintaining a common mode further comprises:
receiving the plurality of reference clock signals from a pre-conditioner circuit;
forcing the common mode of the plurality of reference clock signals to be the same; and
sending the reference clock signals to a mixer circuit.

16. A receiver, comprising:
a local reference clock providing a plurality of clock phases;
a clock and data recovery unit to receive a serial data signal from a transmitter; and
a phase interpolator within the clock and data recovery unit, the phase interpolator including:
an alternating current (AC) coupling capacitor; and
a common mode bias keeper circuit coupled to the AC coupling capacitor,
wherein the AC coupling capacitor and the common bias keeper circuit operate together to force the common mode of phase interpolator input signals to be the same.

17. The receiver of claim 16, the phase interpolator further comprising:
a pre-conditioner circuit;
a mixer circuit; and
an amplifier.

18. The receiver of claim 17, the phase interpolator further comprising the AC coupling capacitor and the common mode bias keeper circuit coupled between the mixer circuit and the amplifier.

19. The receiver of claim 18, the phase interpolator further comprising:
a second AC coupling capacitor coupled between the pre-conditioner circuit and the mixer circuit; and
a second common mode bias keeper circuit coupled to the second AC coupling capacitor.

20. The receiver of claim 17, the phase interpolator further comprising the AC coupling capacitor and the common mode bias keeper circuit coupled between the pre-conditioner circuit and the mixer circuit.
